(19) United States
(12) Patent Application Publication
(10) Pub. No.: US 2026/0313115 A1
(43) Pub. Date: Oct. 8, 2026

(54) METHOD AND DEVICE FOR VIDEO CODING USING LOCAL ILLUMINATION COMPENSATION-BASED PREDICTION IN GEOMETRIC PARTITIONING MODE

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Sea Nae PARK, Seoul (KR); Min Hun LEE, Uijeongbu-si, Gyeonggi-do (KR); Dong Gyu SIM, Seoul (KR); Jin HEO, Yongin-si, Gyeonggi-do (KR); Jung Ah CHOI, Seoul (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/481,367

(22) PCT Filed: May 8, 2024
(86) PCT No.: PCT/KR2024/006159

§ 371 Date: Nov. 4, 2025

(30) Foreign Application Priority Data
May 16, 2023 (KR) 10-2023-0063330
May 7, 2024 (KR) 10-2024-0059764

(51) Int. Cl. H04N 19/119; H04N 19/105; H04N 19/137; H04N 19/176; H04N 19/46; H04N 19/82

(52) U.S. Cl. CPC H04N 19/119; H04N 19/105; H04N 19/137; H04N 19/176; H04N 19/46; H04N 19/82

(57) ABSTRACT

A method and an apparatus are disclosed for video coding using a local illumination compensation-based prediction in geometric partitioning mode. In the disclosed embodiments, the video decoding apparatus decodes a geometric partitioning mode index, and partitions the current block into partitioned blocks according to the geometric partitioning mode index. The video decoding apparatus generates reference blocks of the partitioned blocks by using motion information, and generates a prediction block of the current block by blending the reference blocks. When the neighboring reference pixels of the current block are available, and when the neighboring reference pixels of each reference block of the reference blocks are available in whole or in part, the video decoding apparatus generates, by blending neighboring reference pixels of the reference blocks, neighboring reference pixels of the blended prediction block, and derives parameters of a linear relation between the neighboring reference pixels of the current block and the neighboring reference pixels of the blended prediction block. The video decoding apparatus generates a final prediction block of the current block by applying a local illumination compensation to the blended prediction block based on the parameters of the linear relation.

### TECHNICAL FIELD

The present disclosure relates to a video coding method and an apparatus using a local illumination compensation-based prediction in geometric partitioning mode.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In VVC, geometric partitioning mode (GPM) is adopted as an inter prediction technique to perform prediction according to a more flexible partitioning than square and rectangular partitioning. In GPM technique, the encoder provides the decoder with a mode index indicating one of the predefined geometric partitioning modes and motion information of two partitioned regions. The decoder uses the transmitted information to compensate for the motion of the two partitioned regions and uses a blending matrix according to the geometric partitioning mode to weighted-sum the two partitioned regions and thereby generate the final predicted signals of the current block.

When generating predicted signals of the current block by using inter prediction-based motion compensation, local or global illumination changes may occur between the current frame and the reference frame. Local illumination compensation (LIC) is a technique that can improve the prediction efficiency of the current block by compensating for the changed illumination values. Therefore, to improve video coding efficiency and video quality, there is a need for a method of efficiently utilizing illumination compensation when performing GMP-based inter prediction.

### DISCLOSURE

### Technical Problem

The present disclosure seeks to provide a video coding method and an apparatus that, when a prediction on a current block is performed according to geometric partitioning mode, apply local illumination compensation to predicted signals of the current block to compensate for local or global illumination changes between the current frame and a reference frame.

### Technical Solution

At least one aspect of the present disclosure provides a method for reconstructing a current block by a video decoding apparatus. The method includes decoding a geometric partitioning mode index from a bitstream, and partitioning the current block into partitioned blocks according to the geometric partitioning mode index. The method also includes generating reference blocks of the partitioned blocks by using motion information. Here, the reference blocks include a first reference block and a second reference block. The method also includes generating a prediction block of the current block by blending the reference blocks of the partitioned blocks. The method also includes checking, at a top side and a left side of the current block, availability of neighboring reference pixels of the current block. When the neighboring reference pixels of the current block are available, the method further includes checking, at a top side and a left side of each reference block of the reference blocks, availability of neighboring reference pixels of each reference block. When the neighboring reference pixels of each reference block of the reference blocks are available in whole or in part, the method further includes generating, by blending neighboring reference pixels of the reference blocks, neighboring reference pixels of the blended prediction block. The method further includes deriving parameters of a linear relation between the neighboring reference pixels of the current block and the neighboring reference pixels of the blended prediction block. The method further includes generating a final prediction block of the current block by applying a local illumination compensation to the blended prediction block based on the parameters of the linear relation.

Another aspect of the present disclosure provides a method for encoding a current block by a video encoding apparatus. The method includes determining a geometric partitioning mode index, and partitioning the current block into partitioned blocks according to the geometric partitioning mode index. The method also includes generating reference blocks of the partitioned blocks by using motion information. Here, the reference blocks include a first reference block and a second reference block. The method also includes generating a prediction block of the current block by blending the reference blocks of the partitioned blocks. The method also includes checking, at a top side and a left side of the current block, availability of neighboring reference pixels of the current block. When the neighboring reference pixels of the current block are available, the method further includes checking, at a top side and a left side of each reference block of the reference blocks, availability of neighboring reference pixels of each reference block. When the neighboring reference pixels of each reference block of the reference blocks are available in whole or in part, the method further includes generating, by blending neighboring pixels of the reference blocks, neighboring reference pixels of the blended prediction block. The method further includes deriving parameters of a linear relation between the neighboring reference pixels of the current block and the neighboring reference pixels of the blended prediction block. The method further includes generating a first final prediction block of the current block by applying a local illumination compensation to the blended prediction block based on the parameters of the linear relation.

Yet another aspect of the present disclosure provides a method for providing video data to a video decoding apparatus. The method includes encoding the video data into a bitstream, and transmitting the bitstream to the video decoding apparatus. The encoding of the video data includes determining a geometric partitioning mode index, an partitioning a current block into partitioned blocks according to the geometric partitioning mode index. The encoding of the video data also includes generating reference blocks of the partitioned blocks by using motion information. Here, the reference blocks include a first reference block and a second reference block. The encoding of the video data also includes generating a prediction block of the current block by blending the reference blocks of the partitioned blocks. The encoding of the video data also includes checking, at a top side and a left side of the current block, availability of neighboring reference pixels of the current block. When the neighboring reference pixels of the current block are available, the encoding of the video data further includes checking, at a top side and a left side of each reference block of the reference blocks, availability of neighboring reference pixels of each reference block. When the neighboring reference pixels of each reference block of the reference blocks are available in whole or in part, the encoding of the video data further includes generating, by blending neighboring pixels of the reference blocks, neighboring reference pixels of the blended prediction block. The encoding of the video data further includes deriving parameters of a linear relation between the neighboring reference pixels of the current block and the neighboring reference pixels of the blended prediction block. The encoding of the video data further includes generating a final prediction block of the current block by applying a local illumination compensation to the blended prediction block based on the parameters of the linear relation.

### Advantageous Effects

As described above, the present disclosure provides a video coding method and an apparatus that, when a prediction on a current block is performed according to geometric partitioning mode, apply the local illumination compensation to the predicted signals of the current block to compensate for local or global illumination changes between the current frame and a reference frame. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating block partitioning according to geometric partitioning.

FIGS. 7A and 7B are diagrams illustrating straight lines that split blocks into two parts.

FIG. 8 is a diagram illustrating a geometric partitioning mode (GPM) merge list used for geometric motion prediction.

FIG. 9 is a block diagram showing in detail a part of a video decoding apparatus according to at least one embodiment of the present disclosure.

FIG. 10 is a diagram illustrating the blending of neighboring reference pixels of reference blocks, according to at least one embodiment of the present disclosure.

FIG. 11 is a diagram illustrating the blending of neighboring reference pixels of reference blocks, according to another embodiment of the present disclosure.

FIG. 12 is a diagram illustrating the blending of neighboring reference pixels of reference blocks, according to yet another embodiment of the present disclosure.

FIGS. 13A and 13B are diagrams illustrating blending masks of reference pixels, according at least one embodiment of the present disclosure.

FIGS. 14A and 14B are diagrams illustrating blending masks of reference pixels according to another embodiment of the present disclosure.

FIG. 15 is a flowchart of a method of encoding a current block by a video encoding apparatus, according to at least one embodiment of the present disclosure.

FIG. 16 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

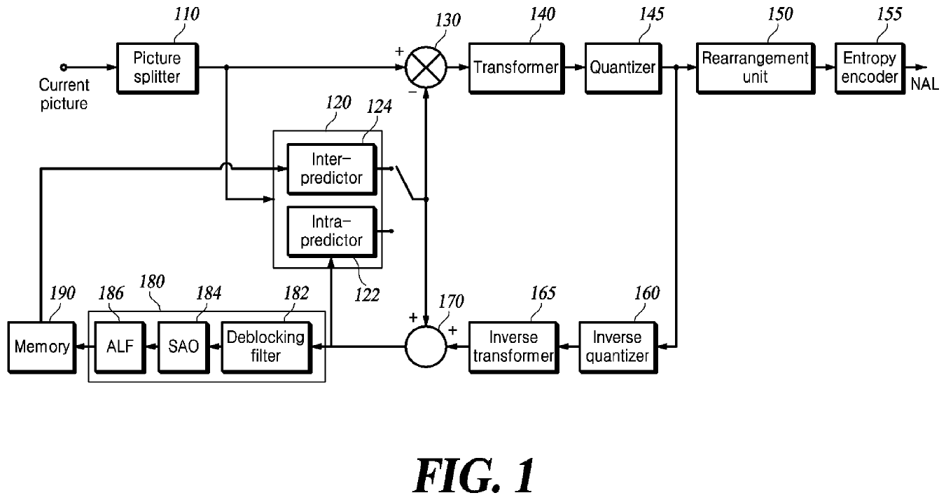

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

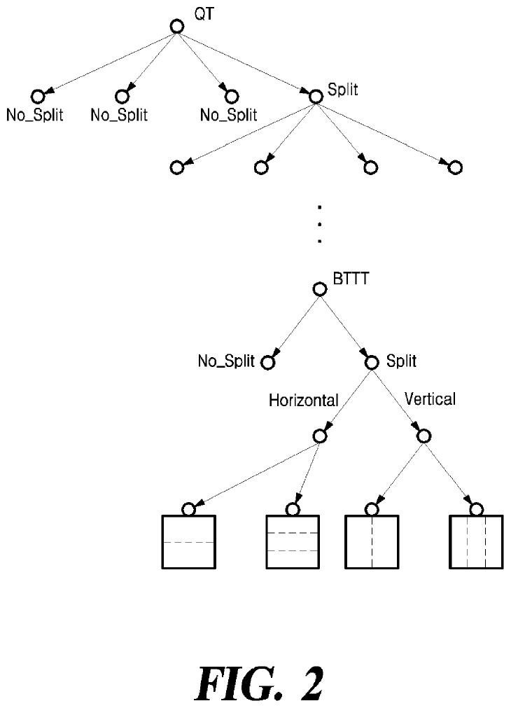

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape. The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

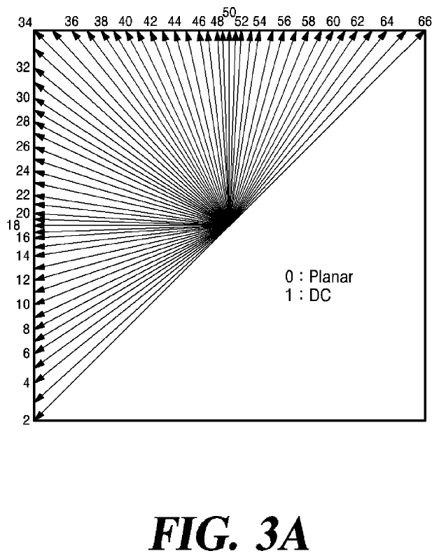

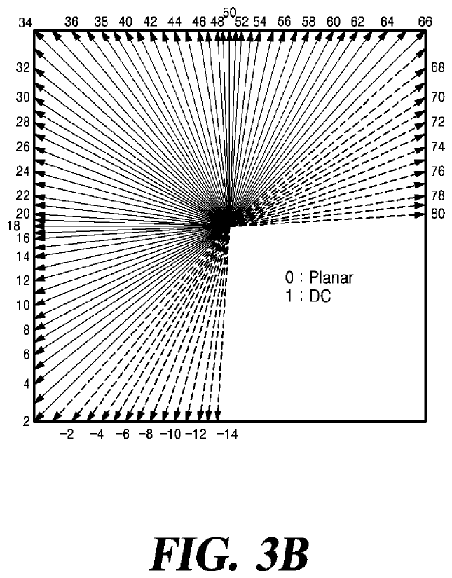

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

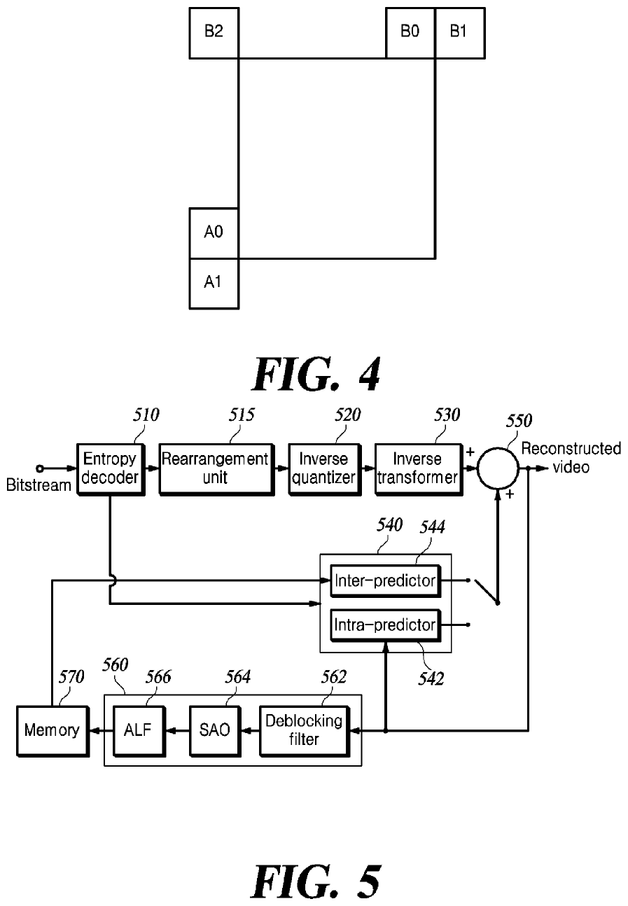

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus apparatuses that, when a prediction performed on a current block is according to geometric partitioning mode, apply the local illumination compensation to the predicted signals of the current block to compensate for local or global illumination changes between the current frame and the reference frame.

The following embodiments may be performed by the inter predictor 124 in the video encoding device. The following embodiments may also be performed by the inter predictor 544 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I-1. Merge/Skip Mode of Inter Prediction and Merge Mode with Motion Vector Difference (MMVD)

The following describes a method of constructing a merge candidate list of motion information in the merge/skip mode of inter prediction. To support the merge/skip mode, the video encoding apparatus may construct the merge candidate list by selecting a preset number (e.g., 6) of merge candidates.

The video encoding apparatus searches for spatial merge candidates. The video encoding apparatus searches for spatial merge candidates from neighboring blocks, as shown in FIG. 4. Up to four spatial merge candidates may be selected.

The video encoding apparatus searches for temporal merge candidates. The video encoding apparatus may add as a temporal merge candidate a block co-located with the current block, which is within a reference picture other than the current picture where the target block is located. Here, the reference picture may be the same as or different from the reference picture used to predict the current block. One temporal merge candidate may be selected.

The video encoding apparatus searches for History-based Motion Vector Predictor (HMVP) candidates. The video encoding apparatus may store the motion vectors of the previous h CUs (where h is a natural number) in a table and may use the motion vectors as merge candidates. The size of the table is 6, and the table stores the motion vectors of the previous CUs in a first-in first-out (FIFO) manner. This indicates that up to 6 HMVP candidates may be stored in the table. The video encoding apparatus may set as merge candidates the most recent motion vectors among the HMVP candidates stored in the table.

The video encoding apparatus searches for Pairwise Average MVP (PAMVP) candidates. The video encoding apparatus may set as a merge candidate the average of the motion vectors of the first and second candidates in the merge candidate list.

If the merge candidate list cannot be filled even after performing all of the above search processes, i.e., if the preset number of merge candidates cannot be recruited, the video encoding apparatus adds zero motion vectors as merge candidates.

In terms of coding efficiency optimization, the video encoding apparatus may determine a merge index that indicates one candidate in the merge candidate list. The video encoding apparatus may use the merge index to derive a motion vector predictor (MVP) from the merge candidate list, and then may determine the MVP as the motion vector of the current block. Additionally, the video encoding apparatus may signal the merge index to the video decoding apparatus.

In skip mode, the video encoding apparatus uses the same motion vector transmission method as in merge mode, but does not transmit the residual block that equals to the difference between the current block and the prediction block.

The above-described method of constructing the merge candidate list may be performed equally by the video decoding apparatus. The video decoding apparatus may decode the merge index. The video decoding apparatus may use the merge index to derive the MVP from the merge candidate list, and then may determine the MVP as the motion vector of the current block.

On the other hand, when using Merge mode with Motion Vector Difference (MMVD) technology, the video encoding apparatus may derive the MVP from the merge candidate list by using the merge index. For example, the first or second candidate in the merge candidate list may be used as the MVP. Additionally, from the perspective of coding efficiency optimization, the video encoding apparatus determines the a distance index and a direction index. The video encoding apparatus may derive the motion vector difference (MVD) by using the distance index and direction index, and then may reconstruct the motion vector of the current block by summing the MVD and MVP. In addition, the video encoding apparatus may signal the merge index, distance index, and direction index to the video decoding apparatus.

The above-described MMVD technique may be performed equally by the inter predictor 544 in the video decoding apparatus. The video decoding apparatus may decode the merge index, distance index, and direction index. The video decoding apparatus may construct the merge candidate list and then may derive the MVP from the merge candidate list by using the merge index. The video decoding apparatus may use the distance index and direction index to derive the MVD, and then may sum the MVD and MVP to reconstruct the motion vector of the current block.

### I-2. Advanced Motion Vector Prediction Mode (AMVP Mode) of Inter Prediction

The following embodiments are described with a focus on the inter predictor 124 within the video encoding apparatus, but as mentioned earlier, they may also be performed by the inter predicting unit 544 in the video decoding apparatus.

The following describes the method of constructing a candidate list of motion information in the Advanced Motion Vector Prediction mode (AMVP mode) of inter prediction. To support the AMVP mode, the inter predictor 124 in the video encoding apparatus may select a preset number (e.g., two) of candidates to form the candidate list.

The video encoding apparatus searches for spatial candidates. The video encoding apparatus searches for spatial candidates from neighboring blocks, as illustrated in FIG. 4. Up to two spatial candidates may be selected.

The video encoding apparatus searches for temporal candidates. The video encoding apparatus may add as a temporal candidate a block that is co-located with the current block and is within a reference picture that is not the current picture holding the target block. Here, the reference picture may be the same as or different from the reference picture used to predict the current block. One temporal candidate may be selected.

If the candidate list cannot be filled even after performing all of the above search processes, i.e., if the preset number of merge candidates cannot be recruited, the video encoding apparatus adds zero motion vectors as merge candidates.

In terms of coding efficiency optimization, the video encoding apparatus may determine a candidate index that indicates one candidate in the candidate list. The video encoding apparatus may use the candidate index to derive MVP (motion vector predictor) from the candidate list. Furthermore, in terms of coding efficiency optimization, the video encoding apparatus determines the motion vector and then subtracts MVP from the motion vector to calculate MVD. Furthermore, the video encoding apparatus may signal the candidate index and MVD to the video decoding apparatus.

The above-described method of constructing the AMVP candidate list may be performed equally by the inter predictor 544 in the video decoding apparatus. The video decoding apparatus may decode the candidate index and MVD. The video decoding apparatus may use the candidate index to derive MVP from the candidate list. The video decoding apparatus may sum the MVD and the MVP to reconstruct the motion vector of the current block.

### I-3. Geometric Partitioning Mode (GPM) of Inter Prediction

The following embodiments are described with a focus on the video decoding apparatus, but they can be implemented in the same or similar manner in the video encoding apparatus.

In versatile video coding (VVC), geometric partitioning mode (GPM) uses prediction units of various shapes rather than rectangular shapes.

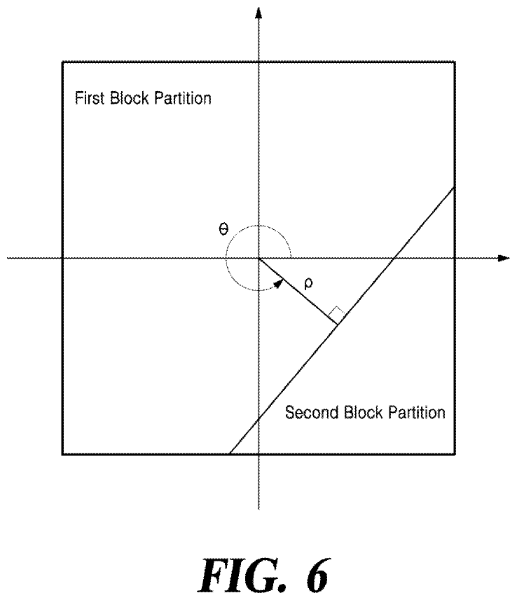

FIG. 6 is a diagram illustrating block partitioning according to geometric partitioning.

The video decoding apparatus divides the current block into two parts by a straight line perpendicular to a line segment with a certain angle θ and a certain distance p from the center of the block. Hereinafter, the two divided blocks are referred to as the first block partition and the second block partition. Block partition is used interchangeably with partitioned block. The straight line that divides the current block is called the partitioning boundary.

Here, the center of the block represents a single virtual position with the current block before partitioning where the ½ position of the height of the block and the ½ position of the width of the block intersect. The angle θ represents the angle rotated counterclockwise from the virtual horizontal axis passing through the center of the block to the line segment perpendicular to the partitioning boundary. The distance p represents the distance between the center of the block and the partitioning boundary.

As described above, the straight line that divides the block into two parts, i.e., the partitioning boundary, divides the current block into two different block partitions. The video decoding apparatus uses the above-described geometric partition to divide the current block into two blocks, the first block partition and the second block partition, which perform separate predictions based on the partitioning boundary.

As an example, in the conventional GPM, information on the partitioning boundary as illustrated in FIG. 6 is signaled from the video encoding apparatus to the video decoding apparatus. The video decoding apparatus may use the parsed partitioning boundary information to decode the geometric block partitions of the current block. Here, the partitioning boundary information may include the angle θ and distance p that are based on the center of the block. Additionally, the video encoding apparatus may further signal information indicating whether GPM is to be applied, to the video decoding apparatus.

Hereinafter, the information on the partitioning boundary according to the geometric partitioning mode is used interchangeably with geometric partitioning mode information, geometric partition information, or partitioning information.

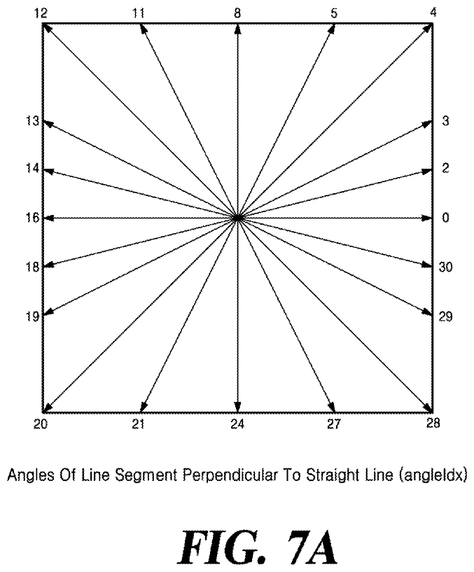

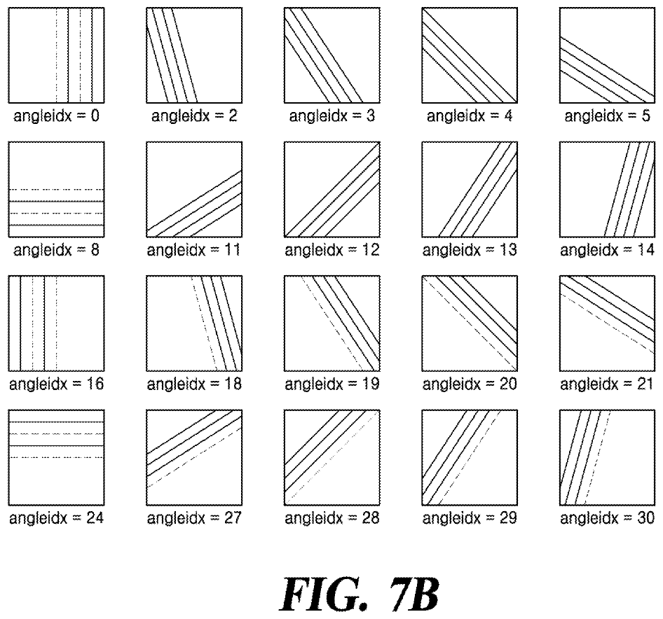

FIGS. 7A and 7B are diagrams illustrating straight lines that split blocks into two parts.

As another example, a lookup table may be configured to include combinations of angles and distances that divide the current block into a first block partition and a second block partition, as shown in FIG. 7A, FIG. 7B, and Table 1. Then, an index indicating the combination of an angle and a distance in the lookup table may be signaled from the video encoding apparatus to the video decoding apparatus. The combinations of angles and distances corresponding to the respective indices may be defined based on a fixed lookup table in accordance with an agreement between the video encoding apparatus and the video decoding apparatus. As a modification, the lookup table may be adaptively reconfigured in accordance with a pre-agreed rule.

As described above, the geometric partition shape is based on a partitioning boundary which is a straight line representing the two partitions of a block. Such information of straight line may include an index distanceIdx representing the distance ρ from the center of the block to the partitioning boundary, and an index angleIdx representing the angle θ of a line segment perpendicular to the partitioning boundary. The indices indicating the angles of the line segment perpendicular to the partitioning boundary may be set as shown in FIG. 7A. Furthermore, the 64 geometric partition shapes based on these angles and distances may be set as shown in FIG. 7B.

The 64 geometric partition shapes may be signaled by using the syntax merge_gpm_partition_idx which is an index indicating the geometric partition shape, as shown in Table 1. Namely, the forms of dividing the current block into the first block partition and the second block partition according to various angles and distances can be efficiently signaled by using a single index.

TABLE 1

| merge_gpm_partition_idx | 0 | 1 | 2 | 3 | 4 | 5 | 6 | 7 |
|---|---|---|---|---|---|---|---|---|
| angleIdx | 0 | 0 | 2 | 2 | 2 | 2 | 3 | 3 |
| distanceIdx | 1 | 3 | 0 | 1 | 2 | 3 | 0 | 1 |
| merge_gpm_partition_idx | 8 | 9 | 10 | 11 | 12 | 13 | 14 | 15 |
| angleIdx | 3 | 3 | 4 | 4 | 4 | 4 | 5 | 5 |
| distanceIdx | 2 | 3 | 0 | 1 | 2 | 3 | 0 | 1 |
| merge_gpm_partition_idx | 16 | 17 | 18 | 19 | 20 | 21 | 22 | 23 |
| angleIdx | 5 | 5 | 8 | 8 | 11 | 11 | 11 | 11 |
| distanceIdx | 2 | 3 | 1 | 3 | 0 | 1 | 2 | 3 |
| merge_gpm_partition_idx | 24 | 25 | 26 | 27 | 28 | 29 | 30 | 31 |
| angleIdx | 12 | 12 | 12 | 12 | 13 | 13 | 13 | 13 |
| distanceIdx | 0 | 1 | 2 | 3 | 0 | 1 | 2 | 3 |
| merge_gpm_partition_idx | 32 | 33 | 34 | 35 | 36 | 37 | 38 | 39 |
| angleIdx | 14 | 14 | 14 | 14 | 16 | 16 | 18 | 18 |
| distanceIdx | 0 | 1 | 2 | 3 | 1 | 3 | 1 | 2 |
| merge_gpm_partition_idx | 40 | 41 | 42 | 43 | 44 | 45 | 46 | 47 |
| angleIdx | 18 | 19 | 19 | 19 | 20 | 20 | 20 | 21 |
| distanceIdx | 3 | 1 | 2 | 3 | 1 | 2 | 3 | 1 |
| merge_gpm_partition_idx | 48 | 49 | 50 | 51 | 52 | 53 | 54 | 55 |
| angleIdx | 21 | 21 | 24 | 24 | 27 | 27 | 27 | 28 |
| distanceIdx | 2 | 3 | 1 | 3 | 1 | 2 | 3 | 1 |
| merge_gpm_partition_idx | 56 | 57 | 58 | 59 | 60 | 61 | 62 | 63 |
| angleIdx | 28 | 28 | 29 | 29 | 29 | 30 | 30 | 30 |
| distanceIdx | 2 | 3 | 1 | 2 | 3 | 1 | 2 | 3 |

The index distanceIdx derived from the example in FIG. 7B is a value excluding the size of the current block. Therefore, the actual distance between the pixels in the current block and the straight line may be calculated by using the size information of the current block, the index angleIdx representing the angle, and the index distanceIdx representing the distance. Here, the actual distance is a value expressed in pixel units.

Meanwhile, the actual distance may be used to calculate the weight of each pixel in the current block. For example, for a single pixel in the first block partition, as the actual distance between the pixel and the straight line increases, the weight of the predictor of the first block partition, as described above, increases, and the weight of the predictor of the second block partition decreases. For pixels located on the partitioning boundary, the two predictors may use weights with the same value. In this case, the sum of the weights of the two predictors for a single pixel is maintained at 1.

On the two different block partitions of the current block existing within the current picture, the video decoding apparatus performs prediction by using each motion vector (mv0 or mv1). The video decoding apparatus applies a weight-based blending process to the prediction block of the first block partition and the prediction block of the second block partition to generate the final prediction block of the current block.

To perform inter prediction of the current block, the video decoding apparatus obtains a first prediction block by using the motion vector of the first block partition and obtains a second prediction block by using the motion vector of the second block partition. At this time, the video decoding apparatus may obtain the prediction block as multiplied by different weights according to the pixel position, as described above, in the process of obtaining the prediction block for each block partition. In addition, the video decoding apparatus may use shift operation and clipping operation in the process of generating the final prediction block from the prediction blocks multiplied by weights.

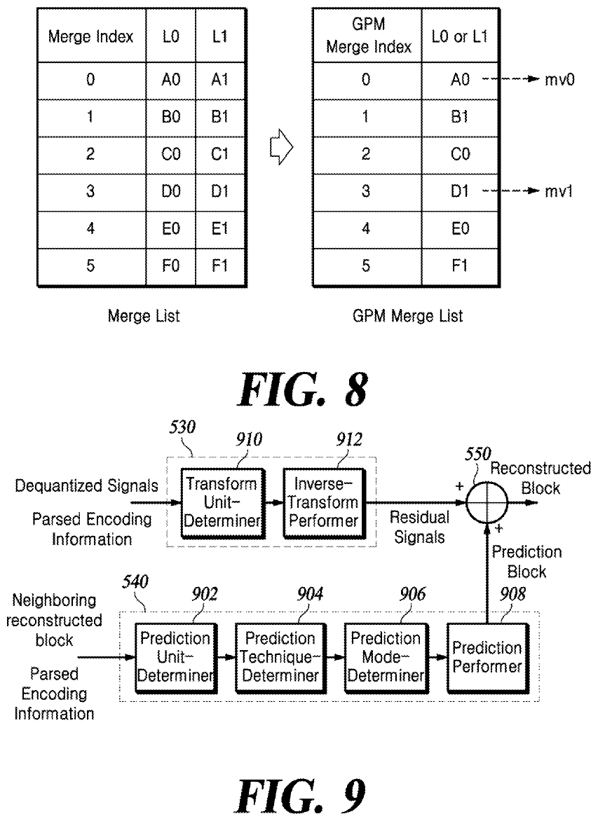

FIG. 8 is a diagram illustrating a geometric partitioning mode (GPM) merge list used for geometric motion prediction.

The video decoding apparatus, as illustrated in FIG. 8, selects motion information for motion prediction from the merge list and then uses the selected motion information.

However, unlike existing block-wise motion prediction techniques, for geometric motion prediction, the video decoding apparatus performs unidirectional prediction on a single block partition by limiting the prediction direction, as shown in FIG. 8. This is because, compared to block-wise motion prediction, in geometric motion prediction, when performing motion prediction by bi-prediction for each block partition, the memory bandwidth used for prediction can be twofold. Therefore, to efficiently address the above-described memory bandwidth increase issue, a technique that limits the directionality of prediction for each block partition may be applied.

In the case where the directionality of prediction is restricted for each block partition in geometric motion prediction, a GPM merge list for geometric motion prediction may be generated by using the existing merge list. To generate the GPM merge list, the video decoding apparatus first constructs the merge list as described above. Then, the video decoding apparatus may generate a GPM merge list for geometric motion prediction by the prediction directionality and the order within the list. At this point, the video decoding apparatus adds L0-direction motion information to the GPM merge list to generate merge candidates for geometric motion prediction of the first block partition. In addition, the video decoding apparatus may add L1-direction motion information to the GPM merge list to generate merge candidates for geometric motion prediction of the second block partition. In other words, the video decoding apparatus may derive unidirectional motion information of one direction from the existing bidirectional motion information and may add the derived motion information to the GPM merge list.

As shown in FIG. 8, in the existing geometric motion prediction method, the video decoding apparatus may use the merge candidate in the GPM merge list directly as motion information for motion prediction of the first block partition and the second block partition.

Meanwhile, the video decoding apparatus may derive motion information related to GPM in a manner similar to that described above even in the AMVP mode of inter prediction.

### II. Local Illumination Compensation (LIC)

When generating predicted signals of the current block by using motion compensation by inter prediction, local or global illumination changes may occur between the current frame and the reference frame. Local illumination compensation (LIC) is a technique that can improve prediction efficiency for the current block by performing illumination compensation according to changes in the image capturing environment.

To effectively perform local illumination compensation, the video decoding apparatus derives parameters representing the linear relational equation between the neighboring L-shaped template of the current block and the neighboring L-shaped template of the reference block. For example, the parameters of the linear relational equation may be derived based on the linear least squares method. At this time, the neighboring L-shaped template of the current block exists in the reconstructed region of the current block. The video decoding apparatus uses the derived parameters of the linear relational equation to perform local illumination compensation of the current block based on the reference block, as shown in Equation 1.

$${P}^{′} ( x , y ) = α \times P ( x , y ) + β \qquad [ Equation 1 ]$$

In Equation 1, α and β are parameters of the linear relational equation, representing the slope and offset, respectively. P(x,y) represents a pixel in the reference block, i.e., a predicted pixel, and P′(x,y) represents a predicted pixel in the current block subjected to local illumination compensation.

As mentioned above, local illumination compensation is applied to the current block, and the linear relational equation is derived based on the neighboring reference pixels adjacent to the reference block and the neighboring reference pixels adjacent to the current block. In this case, when there are no available pixels among the neighboring reference pixels of the reference block, local illumination compensation may not be performed for the current block. When available pixels exist not on both the left and top sides of the reference block but on a portion of the left and top sides, local illumination compensation may be performed by using some existing pixels.

The parameters α and β of the linear relational equation used in local illumination compensation are calculated identically in the video encoding apparatus and the video decoding apparatus. Therefore, the video encoding apparatus may not separately transmit the parameters of the linear relational equation to the video decoding apparatus.

When LIC is applied to a neighboring block selected according to the merge index in merge mode, the video decoding apparatus performs LIC by applying the LIC parameters of the neighboring block to the current block. In AMVP mode, a flag indicating whether LIC is to be performed is signaled, and the video decoding apparatus derives the LIC parameters by using the template of the current block and the template of the reference block. Additionally, LIC is applied in the case of unidirectional prediction, and LIC is not applied when the current block is predicted according to Combined Inter Intra Prediction (CIIP). CIIP is a technique that generates blocks after intra prediction, which are intra-prediction blocks and blocks after inter prediction, which are inter-prediction blocks to the current block, and then weighted-sums the intra-prediction blocks and inter-prediction blocks to generate the final prediction block of the current block.

The following embodiments are described with a focus on the video decoding apparatus, but they may be implemented in the same or similar manner in the video encoding apparatus.

### III. Embodiments According to the Present Disclosure

The video decoding apparatus according to some embodiments may determine prediction and transform units, and in response to a current block corresponding to the determined unit, may perform a prediction and an inverse transform by using a determined prediction technique and prediction mode, to finally generate a reconstructed block of the current block. The operations illustrated in FIG. 9 may be performed by the inverse transformer 530, the predictor 540, and the adder 550 of the video decoding apparatus. On the other hand, the same operations as illustrated in FIG. 9 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a high level in terms of minimizing bit rate distortion. Hereinafter, for convenience, the embodiments are described centering on the video decoding apparatus.

As illustrated in FIG. 5, the predictor 540 includes the intra predictor 542 and the inter predictor 544, depending on the prediction technique, but as illustrated in FIG. 9, the predictor 540 may include all or part of a prediction unit-determiner 902, a prediction technique-determiner 904, a prediction mode-determiner 906, and a prediction performer 908.

When the color format of the input video is a YUV format (YUV420, YUV411, YUV422, YUV444, or the like), the video decoding apparatus may perform prediction and reconstruction of the luma component, and then may perform prediction and reconstruction of the chroma component. In this way, the luma component and the chroma component may be sequentially reconstructed by the components illustrated in FIG. 9. On the other hand, when the color format of the input video is RGB, the video encoding apparatus may perform a color format conversion from RGB to YUV, and then may encode the converted video. Here, in the YUV format, the color format represents a correspondence between pixels in the luma component and pixels in the chroma component.

The prediction unit-determiner 902 determines a prediction unit (PU). The prediction technique-determiner 904, in response to the prediction unit, determines a prediction technique, e.g., intra prediction, inter prediction, or intra block copy (IBC) mode, palette mode, or the like. The prediction mode-determiner 906 determines a detailed prediction mode for the prediction technique. The prediction performer 908 generates a prediction block of the current block according to the determined prediction mode.

The inverse transformer 530 includes a transform unit-determiner 910 and an inverse transform-performer 912. The transform unit-determiner 910 determines a transform unit (TU) in response to the dequantized signals of the current block, and the inverse transform-performer 912 inversely transforms the transform unit represented by the dequantized signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 902 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed in response to the prediction unit of the chroma component.

The prediction technique-determiner 904 determines a prediction technique for the prediction units. As described above, the prediction technique may be one of inter prediction, intra prediction, IBC mode, and palette mode. In this case, the prediction technique for the chroma component may be determined to be the same as the prediction technique of the corresponding luma component without signaling and parsing any additional information.

In one example, when the prediction technique of the current block is not intra prediction, the video decoding apparatus parses the 1-bit flag information. When the parsed flag indicates a skip mode, the video decoding apparatus may determine the prediction mode of the current block to be an inter prediction merge mode or an IBC merge mode. In the skip mode, the video decoding apparatus may also use the predicted signals in place of reconstructed signals, while skipping an inverse transform, i.e., without parsing residual signals.

On the other hand, when the parsed flag does not indicate a skip mode in response to the current block, the prediction technique-determiner 904 may determine one of the prediction techniques, such as inter prediction, intra prediction, IBC mode, palette mode, or the like, by parsing a series of 1-bit flags to be the prediction technique of the current block.

For example, when skip mode is not applied to the current block and the inter prediction or IBC mode is determined to be the prediction technique, the video decoding apparatus parses a 1-bit flag. The video decoding apparatus may determine, based on the parsed flag, the prediction mode of the current block to be the regular merge mode or AMVP (advanced motion vector prediction) mode.

The prediction mode-determiner 906 determines a detailed prediction mode for the prediction technique.

As an example, when the prediction technique of the current block is inter prediction, the prediction mode-determiner 906 may determine the regular merge mode or AMVP mode as the prediction mode of the current block. In the regular merge mode or AMVP mode, the video decoding apparatus generates prediction blocks based on one or more motion compensations based on the parsed motion information, and weighted-sums the multiple generated prediction blocks to generate the final predicted signals of the current block.

In another example, when the prediction technique for the current block is inter prediction, the prediction mode-determiner 906 may determine the geometric partitioning mode (GPM) as the prediction mode of the current block. In GPM, the video decoding apparatus divides the current block into two or more partitioned blocks according to the geometric partition, generates prediction blocks by one or more motion compensations based on the motion information of the parsed current block, and weighted-sums the multiple generated prediction blocks to generate the final predicted signals of the current block. For example, as described above, the current block may be divided into two partitioned blocks.

The prediction performer 908 generates the prediction block of the current block according to the determined prediction technique and prediction mode.

As an example, the prediction performer 908 generates the prediction block of the current block according to the prediction mode, and the adder 550 sums the current block's prediction block and the residual signals to generate the reconstructed block.

Meanwhile, the entropy decoder 510 when subjected to a secondary transform may reconstruct the quantized secondary transform coefficients. On the other hand, with no secondary transform applied, the entropy decoder 510 may reconstruct the quantized primary transform coefficients. The inverse quantizer 520 may apply inverse quantization to the transform coefficients reconstructed based on the quantization parameters to generate inverse quantized transform coefficients.

The transform unit-determiner 910 of the inverse transformer 530 determines the transform unit (TU) for the inverse quantized transform coefficients. At this time, when a single TU is divided into multiple subblocks, a single subblock may be used as a TU.

The inverse transformer 530 when subjected to a secondary transform may determine a non-separable secondary inverse transform kernel and a separable primary inverse transform kernel. On the other hand, with no secondary transform applied, the inverse transformer 530 may determine a separable primary inverse transform kernel or a non-separable primary inverse transform kernel.

Hereinafter, the terms ‘geometric partitioning mode’, ‘GPM partitioning mode’, and ‘partitioning mode according to GPM’ are used interchangeably. Furthermore, as described above, the two partitioned blocks according to GPM are defined as the first partitioned block and the second partitioned block, respectively.

For example, when the prediction technique for the current block is inter prediction and the current block is predicted according to GPM, the prediction performer 908 in the video decoding apparatus according to the present disclosure may predict the current block as follows.

When the current block is predicted according to GPM, the video decoding apparatus generates a merge list according to the regular merge mode, then uses the merge list to generate a GPM (motion vector) merge list. The GPM merge list may be the one illustrated in FIG. 8. The video decoding apparatus decodes gpm_mode_idx and merge_index. Here, gpm_mode_idx, the GPM index, may be merge_gpm_partition_idx according to Table 1 and gpm_mode_idx indicates one of the GPM partitioning modes. merge_index, the merge index, may indicate a motion information predictor within the GPM merge list. The video decoding apparatus determines the geometric partitioning mode according to gpm_mode_idx and uses merge_idx and the GPM merge list to determine the motion information, i.e., the motion vector, for the partitioned blocks.

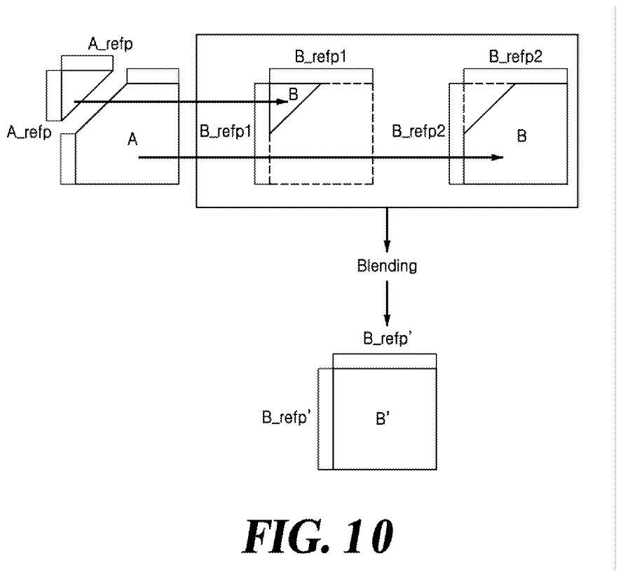

FIG. 10 a diagram illustrating the blending of neighboring reference pixels of reference blocks, according to at least one embodiment of the present disclosure.

The video decoding apparatus calculates a first reference block (B) based on the motion of the top-left block, i.e., the first partitioned block and a second reference block (B) based on the motion vector of the bottom-right block, i.e., the second partitioned block, as shown in the example of FIG. 10. The video decoding apparatus may perform a blending process on the two reference blocks to generate a prediction block (B′), and use the blended prediction block to generate final predicted signals of the current block.

At this time, to apply local illumination compensation to the current block, the video decoding apparatus selects reference pixels, i.e., reference templates of B_refp1 and B_refp2 for local illumination compensation, for the two reference blocks (B), respectively. The video decoding apparatus applies blending mask-based filtering to the reference pixels to derive the neighboring reference pixels B_refp′ of the blended prediction block. The video decoding apparatus uses the post-blending prediction block's neighboring reference pixels B_refp′, i.e., the template of the blended prediction block and the current block's neighboring reference pixels A_refp, i.e., the template of the current block as the basis for calculating the LIC (local illumination compensation) parameters α and β according to a linear relation as shown in Equation 2.

$$A\_refp = α \times {B\_refp}^{′} + β \qquad [ Equation 2 ]$$

Equation 2, for example, may derive the LIC parameters based on the least squares method such as Equations 3 and 4.

$$α = \frac{N \times \sum ( C ( n ) \times R ( n ) ) - \sum ( C ( n ) ) \times \sum ( R ( n ) )}{N \times \sum ( C ( n ) \times C ( n ) ) - \sum ( C ( n ) ) \times \sum ( C ( n ) )} \qquad [ Equation 3 ]$$

$$β = \frac{\sum R ( n ) - α \times \sum C ( n )}{N \times \sum ( C ( n ) \times C ( n ) ) - \sum ( C ( n ) ) \times \sum ( C ( n ) )} \qquad [ Equation 4 ]$$

In Equation 3 and Equation 4, C (n) denotes the pixel values in the current block's template used to derive the LIC parameters, and R (n) denotes the pixel values within the blended prediction block's template used to derive the LIC parameters. N represents the number of pixels used to derive the LIC parameters.

To apply local illumination compensation in geometric partitioning mode, the video decoding apparatus may apply the calculated LIC parameters to the blended prediction block B and thereby generate final predicted signals of the current block.

Hereinafter, the method performed by the video decoding apparatus according to the present disclosure for applying local illumination compensation in GPM mode is described in detail.

The video decoding apparatus uses the decoding of the relevant syntax to determine whether local illumination compensation-based prediction in GPM mode is to be applied. At this time, the determination of whether the LIC-based prediction is to be applied may be transmitted from the video encoding apparatus to the video decoding apparatus by using high level syntax. Alternatively, it may be transmitted from the video encoding apparatus to the video decoding apparatus by using syntax at the level of a specific block size, such as CTU or CU, or syntax at the block group level. The video decoding apparatus uses the decoded syntax as a basis for determining whether the current block is to be predicted according to the geometric partitioning mode and whether local illumination compensation is to be applied. Here, the syntax may include a flag indicating whether GPM mode is to be applied and a flag indicating whether LIC-based prediction is to be applied.

To apply LIC to the current block, the video decoding apparatus determines the availability of neighboring reference pixels used for modeling the linear relation toward local illumination compensation. Here, the availability includes not only the presence or absence of previously decoded neighboring reference pixels that are A_refp, B_refp1, and B_refp2, i.e., reference templates, but also whether the neighboring reference pixels are available for use to apply local illumination compensation to the current block. If the template A_refp of the current block is unavailable for local illumination compensation, the video decoding apparatus may perform predicting/decoding of the current block, overriding steps related to local illumination compensation. Alternatively, the video decoding apparatus may perform prediction/decoding of the current block by setting α to 1 and β to 0, omitting the step of calculating LIC parameters.

When the neighboring reference pixels A_refp of the current block are available, the video decoding apparatus performs a motion vector-based compensation on each of partitioned blocks according to the geometric partitioning mode to determine the partitioned blocks' prediction blocks B, i.e., reference blocks. At this time, as described above, the motion information of the partitioned blocks may be generated from the merge index and the GPM merge list.

The video decoding apparatus determines the availability of B_refp1 and B_refp2, which are neighboring reference pixels of the reference blocks. At this time, even if B exist, their positions may cause all or some of B_refp1 and B_refp2 to be unavailable. If both B_refp1 and B_refp2 are unavailable, the video decoding apparatus may perform prediction/decoding of the current block while omitting steps related to local illumination compensation. Alternatively, the video decoding apparatus may perform prediction/decoding of the current block by setting α to 1 and β to 0, omitting the step of calculating LIC parameters.

When the neighboring reference pixels A_refp of the current block are available and both the neighboring reference pixels B_refp1 and B_refp2 of the reference blocks are available, the video decoding apparatus blends B_refp1 and B_refp2 to generate the neighboring reference pixels B_refp′ of the prediction block. Subsequently, the video decoding apparatus may calculate LIC parameters α and β based on the neighboring reference pixels B_refp′ of the blended prediction block and the neighboring reference pixels A_refp of the current block. It may then apply the calculated LIC parameters to the blended prediction block to generate the final predicted signals of the current block.

As another example, the video decoding apparatus may not use all pixels included in A_refp, B_refp1, and B_refp2. The video decoding apparatus may filter A_refp, B_refp1, and B_refp2 or may extract and generate some pixels from A_refp, B_refp1, and B_refp2, and may use the generated some pixels to calculate the LIC parameters α and β.

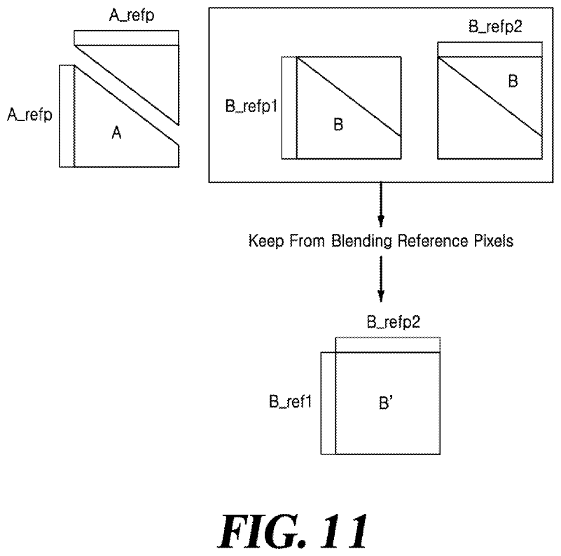

As yet another example, when a certain position of B makes some of B_refp1 and B_refp2 available, the video decoding apparatus may use only the available ones to calculate the LIC parameters α and β. For example, as illustrated in the example of FIG. 11, when only the left pixels of B_refp1 and the top pixels of B_refp2 are available, the video decoding apparatus may replace blending of B_refp1 and B_refp2 with using the left pixels of A_refp, the left pixels of B_refp1, the top pixels of A_refp, and the top pixels of B_refp2 to calculate the LIC parameters α and β.

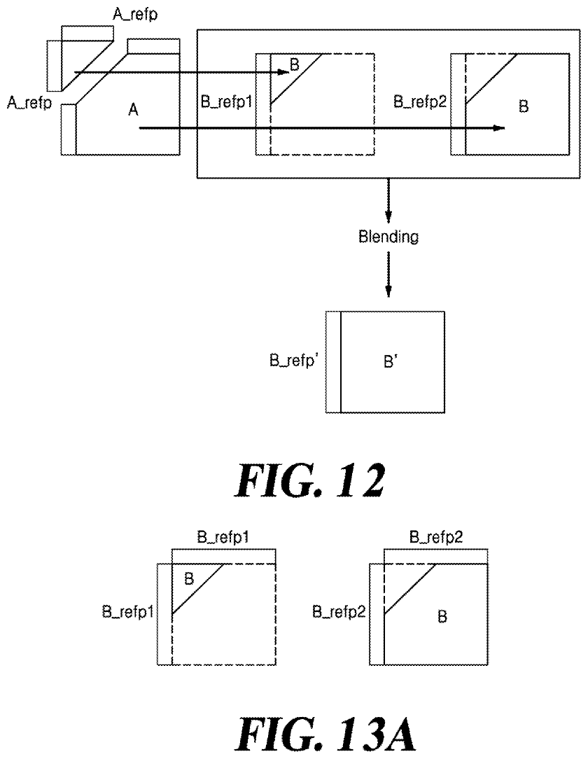

As yet another example, as illustrated in FIG. 12, when only the left pixels of B_ref1 and the left pixels of B_ref2 are available, the video decoding apparatus applies blending to the available pixels to derive B_refp′. The video decoding apparatus may use the left pixels of A_refp and B_refp′ to calculate the LIC parameters α and β.

As yet another example, when only some of B_refp1 and B_refp2 are available, the video decoding apparatus may perform prediction/decoding of the current block while omitting the steps related to local illumination compensation. Alternatively, the video decoding apparatus may perform prediction/decoding of the current block by setting α to 1 and β to 0, omitting the step of calculating the LIC parameters.

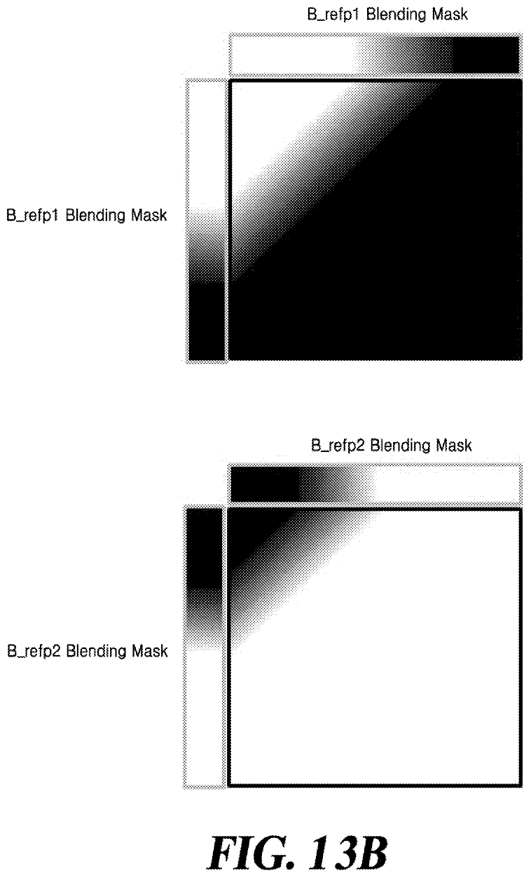

FIGS. 13A and 13B are diagrams illustrating blending masks of reference pixels, according at least one embodiment of the present disclosure.

The video decoding apparatus may use masks of the same shape as those used for B, as the blending masks for blending B_refp1 and B_refp2, as illustrated in FIG. 13A. More precisely, as illustrated in the example of FIG. 13B, the video decoding apparatus may blend the reference pixels by using masks of the same shape as those having been used in the pixel line within the B block, which is most adjacent to the neighboring reference pixels. In the blending masks illustrated in FIG. 13B, the weight of the pixel increases as the pixel color approaches white.

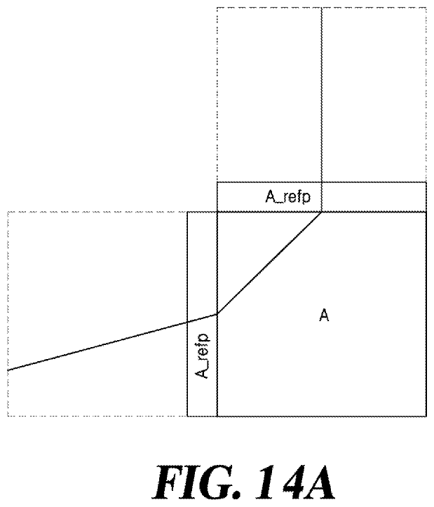

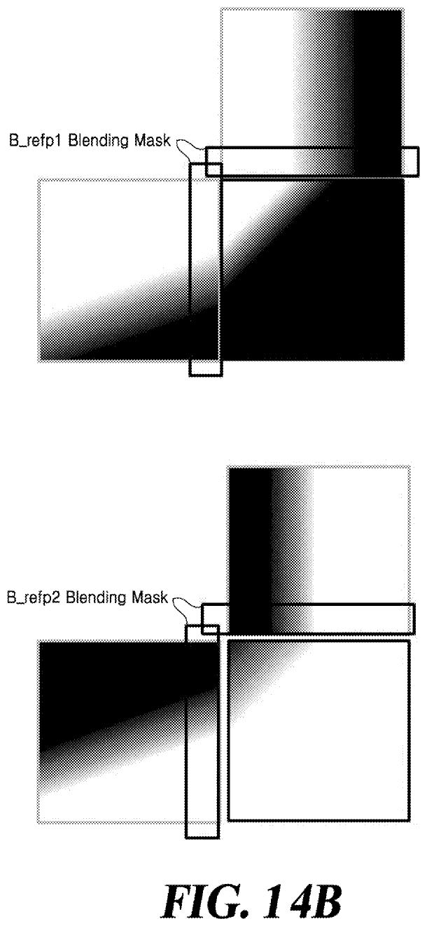

FIGS. 14A and 14B are diagrams illustrating blending masks of reference pixels according to another embodiment of the present disclosure.

As another example, the video decoding apparatus may determine the mask shape by using the partition structure of a block containing A_refp, as illustrated in FIG. 14A, as the blending masks for B_refp1 and B_refp2. The video decoding apparatus may construct the masks according to the determined mask shape, as illustrated in the example of FIG. 14B, and then may use the constructed masks to blend the reference pixels. In the blending masks illustrated in FIG. 14B, the weight of a pixel increases as the pixel color approaches white.

When local illumination compensation is applied, the video decoding apparatus may perform in-loop filtering by reflecting the local illumination compensation. For example, when determining the filtering intensity of the deblocking filter 562 at the boundary between two adjacent blocks, the video decoding apparatus may include the LIC parameters α and β in the parameters determining the filtering intensity. For instance, when (i) local illumination compensation is applied to the blocks containing the target pixels for in-loop filtering and (ii) the α values of two of the blocks containing the target pixels are not 1 and the β values of the two blocks are not 0, even if the reference picture of the two blocks are identical, the video decoding apparatus may determine the BS for determining the filtering intensity of the deblocking filter 562 to 1 to perform filtering at the boundary between the two blocks. Alternatively, if the α values of the two blocks containing the target pixels for filtering are different, the video decoding apparatus may determine the BS to be 1 to determine the filtering intensity of the deblocking filter 562, thereby performing filtering at the border between the two blocks. Furthermore, the foregoing description may also be applied when the video encoding apparatus determines the filtering intensity of the deblocking filter 182.

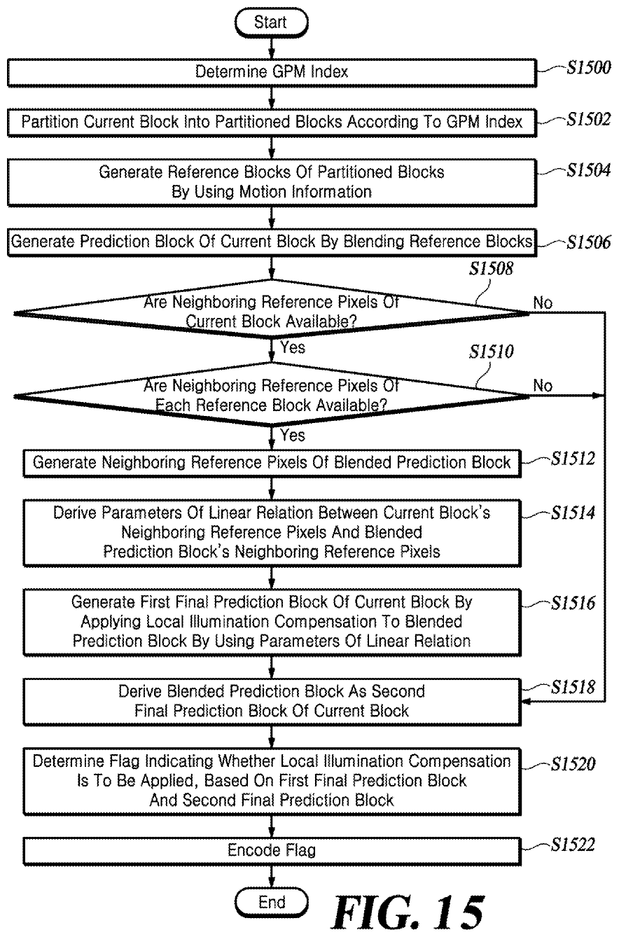

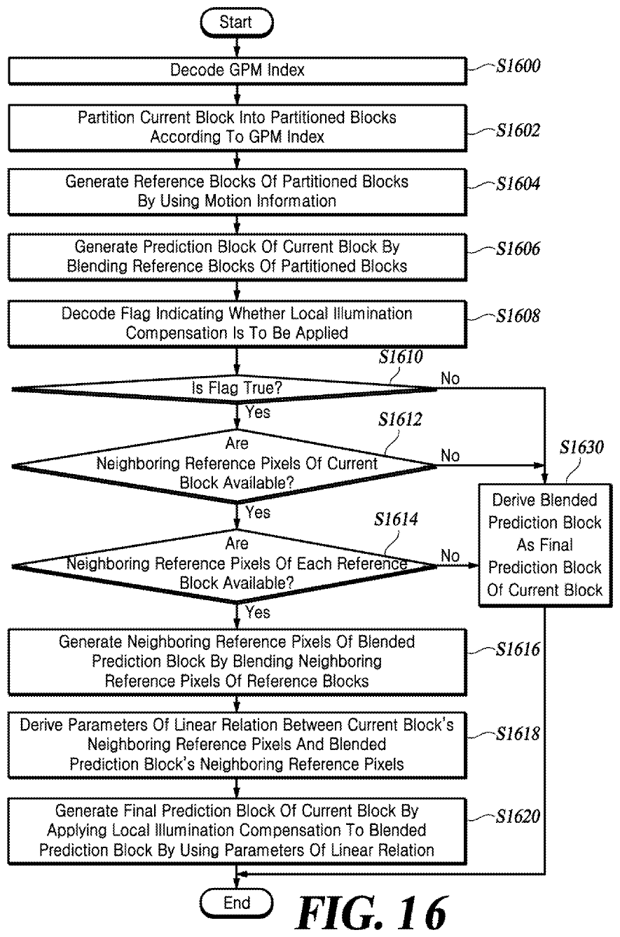

Hereinafter, by using the illustrations of FIGS. 15 and 16, methods of applying LIC when the current block is predicted according to GPM are described.

FIG. 15 is a flowchart of a method of encoding a current block by the video encoding apparatus, according to at least one embodiment of the present disclosure.

The video encoding apparatus determines a GPM index (S1500). From a rate-distortion optimization perspective, the video encoding apparatus may determine a GPM index indicating the geometric partition shape of the current block.

The video encoding apparatus partitions the current block into partitioned blocks according to the GPM index (S1502). For example, the current block may be partitioned into a first partitioned block and a second partitioned block.

The video encoding apparatus generates a merge list according to a regular merge mode, and then uses the merge list to generate a GPM (motion vector) merge list. From a rate-distortion optimization perspective, the video encoding apparatus may determine a merge index. The video encoding apparatus uses the merge index and the GPM merge list to determine the motion information of the partitioned blocks.

The video encoding apparatus uses the motion information to generate reference blocks of the partitioned blocks (S1504). Here, the reference blocks include a first reference block and a second reference block. The first reference block and the second reference block correspond to the first partitioned block and the second partitioned block, respectively.

The video encoding apparatus blends the reference blocks of the partitioned blocks to generate a prediction block of the current block (S1506).

The video encoding apparatus performs the following steps to determine the availability status of neighboring reference pixels used for linear modeling for local illumination compensation. Here, the availability may include not only the presence or absence of previously decoded neighboring reference pixels (A_refp, B_refp1, and B_refp2), but also whether neighboring reference pixels are available for use in applying local illumination compensation to the current block.

The video encoding apparatus checks, at the top and left of the current block, the availability of the neighboring reference pixels of the current block (S1508).

When the neighboring reference pixels (A_refp) of the current block are available (Yes in S1508), the video encoding apparatus performs the following steps.

The video encoding apparatus checks, at the top and left of the respective reference blocks, the availability of the neighboring reference pixels of the respective reference blocks (S1510).

For example, as illustrated in FIG. 11 or 12, if some of the neighboring reference pixels (B_refp1) of the first reference block and some of the neighboring reference pixels (B_refp2) of the second reference block are available, the video encoding apparatus may use the available B_refp1 and B_refp2.

If all or some of the neighboring reference pixels (B_refp1 and B_refp2) of the respective reference blocks are available (Yes in S1510), the video encoding apparatus performs the following steps.

The video encoding apparatus blends the neighboring reference pixels of the reference blocks to generate the neighboring reference pixels of the blended prediction block (S1512).

The video encoding apparatus derives parameters of the linear relation between the current block's neighboring reference pixels and the neighboring reference pixels of the blended prediction block (S1514).

For example, the video encoding apparatus selects pixels used for linear modeling from the current block's neighboring reference pixels (A_refp) and the neighboring reference pixels (B_refp′) of the blended prediction block, and then uses the selected reference pixels to calculate the parameters α and β of the linear relation. The pixels used to calculate the parameters may be all or some of the current block's neighboring reference pixels (A_refp) and the neighboring reference pixels (B_refp′) of the blended prediction block. In this case, the post-blending prediction block's neighboring reference pixels corresponding in position to the neighboring reference pixels of the current block are used for the derivation of the parameters.

The video encoding apparatus uses the parameters of the linear relation to apply local illumination compensation to the blended prediction block and thereby generate a first final prediction block of the current block (S1516).

If the neighboring reference pixels (A_refp) of the current block are unavailable (No in S1508), or if the neighboring reference pixels (B_refp1 and B_refp2) of the reference blocks are unavailable (No in S1510), the video encoding apparatus derives the blended prediction block as a second final prediction block of the current block (S1518). For example, the video encoding apparatus keeps from performing operations related to local illumination compensation and generates the second final prediction block of the current block. Alternatively, the video encoding apparatus omits the process of deriving the parameters of the linear relation. Namely, the video encoding apparatus generates the second final prediction block of the current block by assigning 1 to α and 0 to β, thereby omitting local illumination compensation.

The video encoding apparatus determines a flag indicating whether local illumination compensation is to be applied, based on the first final prediction block and the second final prediction block (S1520).

From a rate-distortion optimization perspective, the video encoding apparatus may determine the flag indicating whether local illumination compensation is to be applied. For example, if the first final prediction block is optimal, the video encoding apparatus sets the flag to true. Conversely, if the second final prediction block is optimal, the video encoding apparatus sets the flag to false.

The video encoding apparatus encodes the flag (S1522).

For example, the video encoding apparatus may determine whether local illumination compensation is to be applied to an image or slice. The flag indicating whether local illumination compensation is to be applied may be transmitted by using high level syntax, or using syntax at the block group level (e.g., CTU, CU) or block level.

Depending on the value of the flag indicating whether local illumination compensation is to be applied, the video encoding apparatus subtracts either the first final prediction block or the second final prediction block from the current block to generate a residual block. The video encoding apparatus then transforms/quantizes the residual block to generate and encode quantized transform coefficients.

FIG. 16 is a flowchart of a method of reconstructing a current block by the video decoding apparatus, according to at least one embodiment of the present disclosure.

The video decoding apparatus decodes a GPM index from the bitstream (S1600).

The video decoding apparatus partitions the current block into partitioned blocks according to the GPM index (S1602). For example, the current block may be partitioned into a first partitioned block and a second partitioned block.

The video decoding apparatus generates a merge list according to a regular merge mode, then uses the merge list to generate a GPM (motion vector) merge list. The video decoding apparatus may decode a merge index from the bitstream. The video decoding apparatus uses the merge index and the GPM merge list to determine the motion information of the partitioned blocks.

The video decoding apparatus uses the motion information to generate reference blocks of the partitioned blocks (S1604). Here, the reference blocks include a first reference block and a second reference block. At this time, the first reference block and the second reference block correspond to the first partitioned block and the second partitioned block, respectively.

The video decoding apparatus blends the reference blocks of the partitioned blocks to generate a prediction block of the current block (S1606).

The video decoding apparatus decodes from the bitstream a flag indicating whether local illumination compensation is to be applied (S1608).

For example, the video decoding apparatus may determine whether local illumination compensation is to be applied to an image or slice. The flag indicating whether local illumination compensation is to be applied may be transmitted by using high level syntax, or using block group-level syntax at, for example, CTU or CU level, or block-level syntax.

The video decoding apparatus checks the flag (S1610).

If the flag indicating whether local illumination compensation is to be applied is true (Yes in S1610), the video decoding apparatus performs the following steps to determine the availability status of neighboring reference pixels used for linear modeling toward local illumination compensation. Here, the availability may include not only the presence or absence of previously decoded neighboring reference pixels (A_refp, B_refp1, and B_refp2), but also whether neighboring reference pixels are available for use in applying local illumination compensation to the current block.

The video decoding apparatus checks the availability of the neighboring reference pixels of the current block (S1612).

If the neighboring reference pixels (A_refp) of the current block are available (Yes in S1612), the video decoding apparatus performs the following steps.

The video decoding apparatus checks, at the top and left of the respective reference blocks, the availability of the neighboring reference pixels of the respective reference blocks (S1614).

For example, as illustrated in the examples of FIG. 11 or FIG. 12, if some of the neighboring reference pixels (B_refp1) of the first reference block and some of the neighboring reference pixels (B_refp2) of the second reference block are available, the video decoding apparatus may use the available B_refp1 and B_refp2.

When all or some of the neighboring reference pixels (B_refp1 and B_refp2) of the respective reference blocks are available, the video decoding apparatus performs the following steps.

The video decoding apparatus blends the neighboring reference pixels of the reference blocks to generate the neighboring reference pixels of the blended prediction block (S1616).

The video decoding apparatus derives parameters of the linear relation between the current block's neighboring reference pixels and the neighboring reference pixels of the blended prediction block (S1618).

For example, the video decoding apparatus selects pixels used for linear modeling from the current block's neighboring reference pixels (A_refp) and the neighboring reference pixels (B_refp′) of the blended prediction block, and then uses the selected reference pixels to calculate the parameters α and β of the linear relation. The pixels used to calculate the parameters may be all or some of the current block's neighboring reference pixels (A_refp) and the neighboring reference pixels (B_refp′) of the blended prediction block. In this case, the post-blending prediction block's neighboring reference pixels corresponding in position to the neighboring reference pixels of the current block are used to derive the parameters.

The video decoding apparatus uses the parameters of the linear relation to apply local illumination compensation to the blended prediction block and thereby generate the final prediction block of the current block (S1620).

Conversely, if the flag indicating whether local illumination compensation is to be applied is false (No in S1610), or if the current block's neighboring reference pixels (A_refp) are unavailable (No in S11612), or if the reference blocks's neighboring reference pixels (B_refp1 and B_refp2) are unavailable (No in S11614), the video decoding apparatus derives the blended prediction block as the final prediction block of the current block (S1630).

As another example, when some of the neighboring reference pixels (B_refp1 and B_refp2) of the reference block are available, the video decoding apparatus also derives the blended prediction block as the final prediction block of the current block.

For example, the video decoding apparatus keeps from performing operations related to local illumination compensation and generates the final prediction block of the current block. Alternatively, the video decoding apparatus omits the process of deriving the parameters of the linear relation. Namely, the video decoding apparatus generates the final prediction block of the current block by assigning 1 to α and 0 to β, thereby omitting local illumination compensation.

The video decoding apparatus decodes the quantized transform coefficients from the bitstream, inversely quantizes/inversely transforms the quantized transform coefficients to reconstruct the residual block. The video decoding apparatus sums the final prediction block of the current block and the residual block to generate the reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
544: inter predictor
902: prediction unit-determiner
904: prediction technique-determiner
906: prediction mode-determiner
908: prediction performer

### CROSS-REFERENCE TO RELATED APPLICATIONS

This application claims priority to and the benefit of Korean Patent Application No. 10-2023-0063330 filed on May 16, 2023, and Korean Patent Application No. 10-2024-0059764, filed on May 7, 2024, the entire contents of each of which are incorporated herein by reference.

1. A method for reconstructing a current block by a video decoding apparatus, the method comprising:
decoding a geometric partitioning mode index from a bitstream;
partitioning the current block into partitioned blocks according to the geometric partitioning mode index;
generating reference blocks of the partitioned blocks by using motion information, the reference blocks including a first reference block and a second reference block;
generating a prediction block of the current block by blending the reference blocks of the partitioned blocks; and
checking, at a top side and a left side of the current block, availability of neighboring reference pixels of the current block,
wherein the method further comprises, when the neighboring reference pixels of the current block are available:
checking, at a top side and a left side of each reference block of the reference blocks, availability of neighboring reference pixels of each reference block, and
wherein the method further comprises, when the neighboring reference pixels of each reference block of the reference blocks are available in whole or in part:
generating, by blending neighboring reference pixels of the reference blocks, neighboring reference pixels of the blended prediction block;
deriving parameters of a linear relation between the neighboring reference pixels of the current block and the neighboring reference pixels of the blended prediction block; and
generating a final prediction block of the current block by applying a local illumination compensation to the blended prediction block based on the parameters of the linear relation.

2. The method of claim 1, further comprising:
decoding from the bitstream a flag indicating whether the local illumination compensation is to be applied; and
checking the flag,
wherein, when the flag is true, the method proceeds with checking the availability of the neighboring reference pixels of the current block.

3. The method of claim 1, further comprising:
when the flag is false, deriving the blended prediction block as final predicted signals of the current block.

4. The method of claim 1, further comprising, when the neighboring reference pixels of the current block are unavailable, or when the neighboring reference pixels of each reference block of the reference blocks are unavailable:
deriving the blended prediction block as final predicted signals of the current block.

5. The method of claim 1, wherein deriving the parameters of the linear relation comprises:
deriving the parameters by applying a linear least squares method to the neighboring reference pixels of the current block and the neighboring reference pixels of the blended prediction block.

6. The method of claim 1, wherein deriving the parameters of the linear relation comprises, when neighboring reference pixels of a left side of the first reference block and neighboring reference pixels of a top side of the second reference block are exclusively available:
keeping from blending the neighboring reference pixels of the left side of the first reference block and the neighboring reference pixels of the top side of the second reference block, but utilizing the neighboring reference pixels of the left side of the current block, the neighboring reference pixels of the left side of the first reference block, the neighboring reference pixels of the top side of the current block, and the neighboring reference pixels of the top side of the second reference block, to proceed with deriving the parameters of the linear relation.

7. The method of claim 1, wherein generating the neighboring reference pixels of the blended prediction block comprises, when neighboring reference pixels of a left side of the first reference block and neighboring reference pixels of a left side of the second reference block are exclusively available:
generating the neighboring reference pixels of a left side of the blended prediction block by blending the neighboring reference pixels of the left side of the first reference block and the neighboring reference pixels of the left side of the second reference block.

8. The method of claim 7, wherein deriving the parameters of the linear relation comprises:
utilizing the neighboring reference pixels of the left side of the current block and the neighboring reference pixels of the left side of the blended prediction block, to proceed with deriving the parameters of the linear relation.

9. The method of claim 1, wherein generating the neighboring reference pixels of the blended prediction block comprises:
blending the neighboring reference pixels of the reference blocks by using a blending mask that is same as used to generate the blended prediction block.

10. The method of claim 1, wherein generating the neighboring reference pixels of the blended prediction block comprises:
blending the neighboring reference pixels of the reference blocks by using a blending mask determined according to a partition structure of a block containing the current block.

11. The method of claim 1, further comprising:
applying in-loop filtering to a boundary between the final prediction block that the local illumination compensation has been applied to and an adjacent block,
wherein applying the in-loop filtering comprises:
determining a filtering intensity at the boundary by using parameters of linear relations of the final prediction block and the adjacent block.

12. A method for encoding a current block by a video encoding apparatus, the method comprising:
determining a geometric partitioning mode index;
partitioning the current block into partitioned blocks according to the geometric partitioning mode index;
generating reference blocks of the partitioned blocks by using motion information, the reference blocks including a first reference block and a second reference block;
generating a prediction block of the current block by blending the reference blocks of the partitioned blocks; and
checking, at a top side and a left side of the current block, availability of neighboring reference pixels of the current block,
wherein the method further comprises, when the neighboring reference pixels of the current block are available,
checking, at a top side and a left side of each reference block of the reference blocks, availability of neighboring reference pixels of each reference block, and
wherein the method further comprises, when the neighboring reference pixels of each reference block of the reference blocks are available in whole or in part,
generating, by blending neighboring pixels of the reference blocks, neighboring reference pixels of the blended prediction block;
deriving parameters of a linear relation between the neighboring reference pixels of the current block and the neighboring reference pixels of the blended prediction block; and
generating a first final prediction block of the current block by applying a local illumination compensation to the blended prediction block based on the parameters of the linear relation.

13. The method of claim 12, further comprising:
deriving the blended prediction block as a second final prediction block of the current block;
determining a flag indicating whether the local illumination compensation is to be applied, based on the first final prediction block and the second final prediction block; and
encoding the flag.

14. The method of claim 12, further comprising, when the neighboring reference pixels of the current block are unavailable, or when the neighboring reference pixels of each reference block of the reference blocks are unavailable:
skipping generating the first final prediction block.

15. A method for providing video data to a video decoding apparatus, the method comprising:
encoding the video data into a bitstream; and
transmitting the bitstream to the video decoding apparatus,
wherein encoding the video data comprises:
determining a geometric partitioning mode index;
partitioning a current block into partitioned blocks according to the geometric partitioning mode index;
generating reference blocks of the partitioned blocks by using motion information, the reference blocks including a first reference block and a second reference block;
generating a prediction block of the current block by blending the reference blocks of the partitioned blocks; and
checking, at a top side and a left side of the current block, availability of neighboring reference pixels of the current block,
wherein the encoding of the video data further comprises, when the neighboring reference pixels of the current block are available,
checking, at a top side and a left side of each reference block of the reference blocks, availability of neighboring reference pixels of each reference block, and
wherein the encoding of the video data further comprises, when the neighboring reference pixels of each reference block of the reference blocks are available in whole or in part,
generating, by blending neighboring pixels of the reference blocks, neighboring reference pixels of the blended prediction block;
deriving parameters of a linear relation between the neighboring reference pixels of the current block and the neighboring reference pixels of the blended prediction block; and
generating a final prediction block of the current block by applying a local illumination compensation to the blended prediction block based on the parameters of the linear relation.
